(19) United States
(12) Patent Application Publication
(10) Pub. No.: US 2003/0055650 A1
(43) Pub. Date: Mar. 20, 2003

(54) Speech apparatus responsive to car stereo operation

(75) Inventor: Stephen Chen, Chang-Hua (TW)

Correspondence Address: DOUGHERTY & TROXELL, 5205 LEESBURG PIKE, SUITE 1404, FALLS CHURCH, VA, 22041, US

(73) Assignee: E-Lead Electronic Co., Ltd.

(21) Appl. No.: 09/955,192

(22) Filed: Sep. 19, 2001

(51) Int. Cl. G10L 21/00

(52) U.S. Cl. 704/270

(57) ABSTRACT

A speech apparatus linking to a car stereo system allows users getting immediate reminding responses in an audio speech fashion when operating the car stereo (such as notifying the identity of the CD or radio station being selected) to free users from repetitive trying or confirming. The apparatus consists of a speech recording and playback unit, a speech recorder, a reminder recorder, a second audio selection unit, an audio mixer, a microphone, a first audio processing unit and a second audio processing unit. When linking to the car stereo system, the apparatus provides an user-friendly and convenient operation for the car stereo system.

### BACKGROUND OF THE INVENTION

1. Field of the Invention

The invention relates to a speech responsive apparatus capable of responding to car stereo operation and particularly an apparatus that employs users' pre-recording reminding speeches to respond users' operation results for the car stereo system and to free the users from operation inconveniences.

2. Description of the Prior Art

Cars have become indispensable transportation means to many people in their daily lives in modern time. Many people have spent a lot of time in the cars. Therefore, the design and production of the cars have evolved from simple transportation means to include recreational and business related function. The interiors of the cars also have equipped with various amenities such as air conditioning, stereo systems and the like to make the drivers and passengers more comfortable and constantly informed. Car radio and stereo system is an especially important facility which can provide people instant information or relaxation. However there is a significant drawback in the commonly used car stereo systems, i.e. users' operations cannot get instant response and confirmation. FIG. 1 illustrates a conventional car stereo system which includes a stereo control unit A3, a display unit A1, a first human interface A2, a FM/AM unit A4, a tape playback unit A5, a CD playback unit A6, a first audio selection unit A7 and a plurality of speakers A8. The car stereo A thus constructed can only provide FM/AM broadcasting, and play tapes or CDs. Whereas, when selecting a CD or a radio station, users usually do not know immediately if the CD or radio station is the right one which the users actually want. It takes some time after the CD is played or radio broadcasting is delivered then users are aware that the selection was correct or wrong. If it turns out incorrect, users have to select another CD or another radio station, and wait another period of time. Such actions and operations could repeatedly happen. It often causes drivers distraction and operating troubles.

### SUMMARY OF THE INVENTION

In view of aforesaid disadvantages, the present invention aims at providing a solution that employs pre-recording reminding speeches to respond car stereo operations to overcome the problems of no immediate responses or confirmations.

The primary object of the invention is to provide a speech responsive apparatus that can respond to car stereo operations to quickly confirm users' selections and offer more user-friendly car stereo operations.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a block diagram of a conventional car stereo system.

FIG. 2 is an architecture block diagram for an embodiment of the invention.

FIGS. 3A, 3B is a process flow chart for recording speeches of the invention.

FIG. 4 is a process flow chart for playing speeches of the invention.

FIG. 5 is an architecture block diagram for a second embodiment of the invention.

FIG. 6 is an architecture block diagram for a third embodiment of the invention.

FIG. 7 is an architecture block diagram for a fourth embodiment of the invention.

FIG. 8 is an architecture block diagram for a fifth embodiment of the invention.

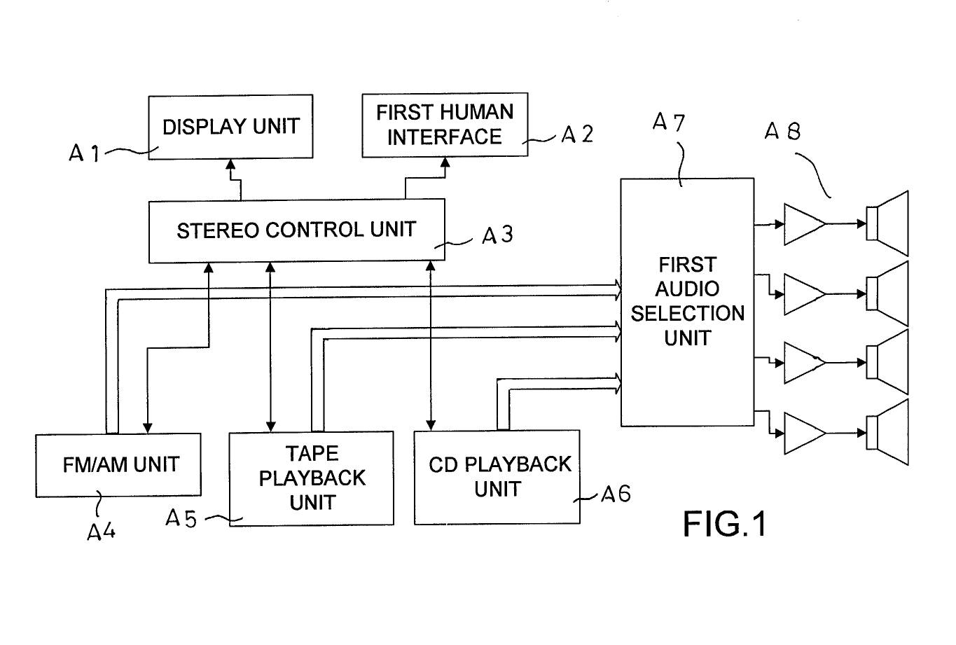

### DESCRIPTION OF THE PREFERRED EMBODIMENTS

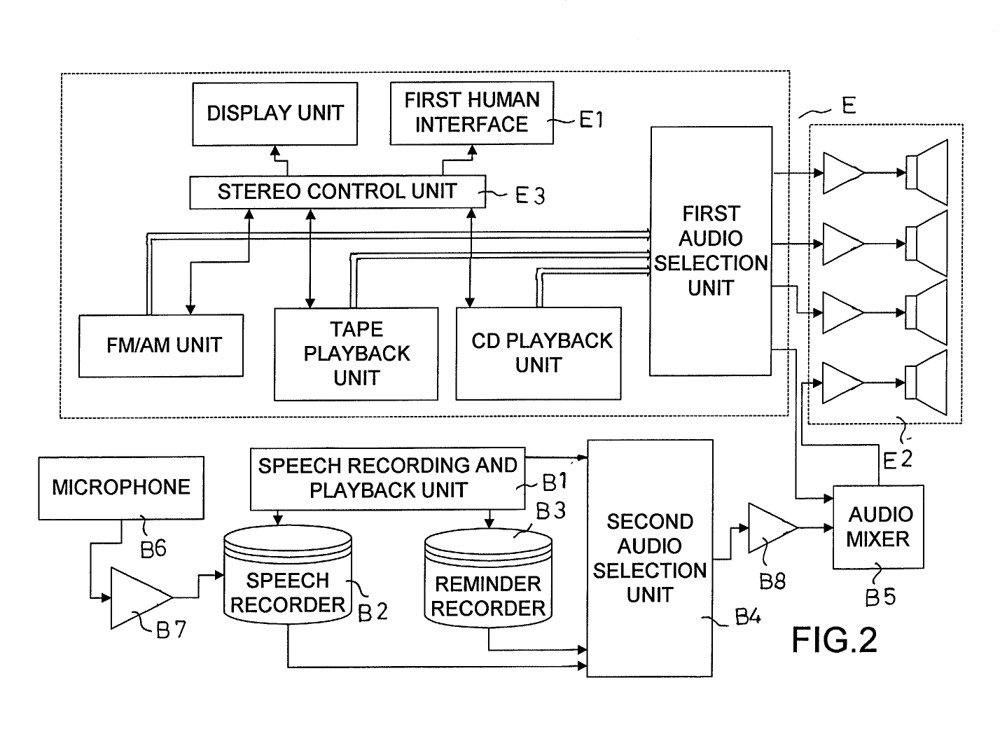

Referring to FIG. 2 for the system architecture of an embodiment of the invention, the invention mainly includes a speech recording and playback unit, a speech recorder, a reminder recorder, a second audio selection unit, an audio mixer, a microphone, a first audio processing unit and a second audio processing unit.

The speech recording and playback unit B1 links to a car stereo control unit E3 to control the tuning down or muting of the car stereo E, and to control the reminder recorder B3, speech recorder B2, and second audio selection unit B4 to allow users to record or broadcast the instructions or reminding speeches.

The speech recorder B2 stores operation guiding speeches for leading users, including recording guides, operation guides and the like.

The reminder recorder B3 temporarily stores users' recording speech data.

The second audio selection unit B4 is controlled by the speech recording and playback unit B1 to restrict speech signal output from the speech recorder B2 or the reminder recorder B3.

The audio mixer B5 blends the speech signals output from the second audio selection unit B4 and car stereo E, and to deliver through the speaker E2.

The microphone B6 allows users to input speech signals.

The first audio processing unit B7 performs speech input related processes such as eliminating distortions, noises, echoes, or the like.

The second audio processing unit B8 processes speech signals output from the second audio selection unit B4 (such as to amplify the sound, eliminating noises and the like which are audio output related), and through the audio mixer B5 to output at the speaker E2 of the car stereo E.

By means of the foregoing construction, users can get correct confirmation immediately regard the choices be made without the need to do trial-hearing repeatedly.

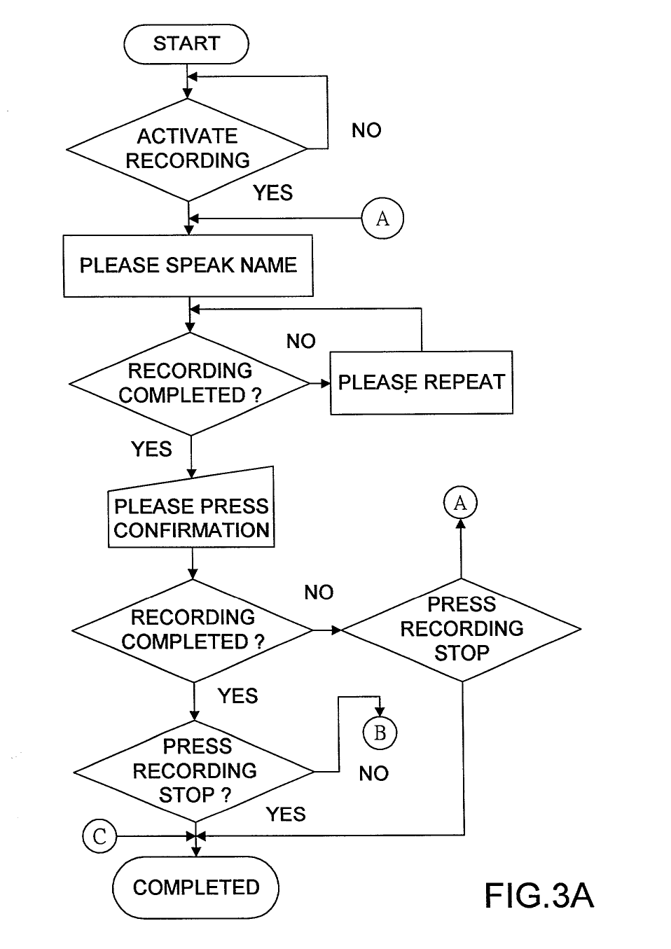

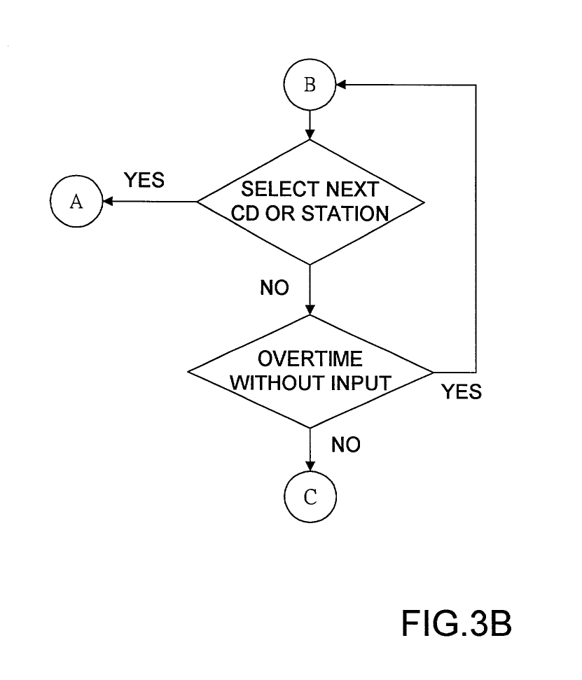

FIGS. 2, 3A and 3B depict operation processes of the invention which consists of the following steps:

1. Users utilize the first human interface E1 of the car stereo E to activate the function of recording the reminding speeches.

2. The speech recording and playback unit B1 controls the car stereo E to make it temporarily mute or tuning down, and through the speech recorder B2 to retrieve the operation guiding speeches corresponding to the operations for recording the reminding speeches, and through the second audio selection unit B4 to output the guiding speeches stored in the speech recorder B2 thereby to guide users to record the reminding speeches step by step (such as: please use microphone to speak the reminding speeches for this CD or station).

3. Users have completed input of speech recording, the speech recorder B2 outputs guiding speeches which are for requesting users to press the confirmation button on the first human interface E1.

4. Proceed decision on whether to stop recording regardless users utilized the first human interface E1 to press the confirmation button.

5. If users did not press the confirmation button through the first human interface E1, the speech recorder B2 outputs guiding speeches and requests users to utilize the first human interface E1 to confirm whether the recording is closed. If the recording stop button is pushed down, it indicates that users have completed the recording and finished the recording job. Otherwise, it indicates that users are not satisfied with the reminding speeches being recorded, then return to the step 2 to record the reminding speeches again.

6. If users utilize the first human interface E1 to press the confirmation button, the speech recorder B2 will output guiding speeches and requests users to utilize the first human interface E1 to confirm whether the recording is closed. If the recording stop button is pushed down, it indicates that users have completed the recording and finished the recording job. Otherwise, determine if users want to continue recording the next CD or station.

7. The speech recorder B2 outputs guiding speeches requesting users to utilize the first human interface E1 to select the next CD or station, and requests users to confirm if to record the reminding speeches. If users select recording, repeat the step 2; otherwise enter the overtime decision process.

8. In the overtime decision process, users might choose not to continue recording of the reminding speeches, then branch to the step 8; otherwise, it indicates that the selected station or CD is not the one which users want to record. After waiting for a period of time, the apparatus of the invention will repeat the step 7.

9. End.

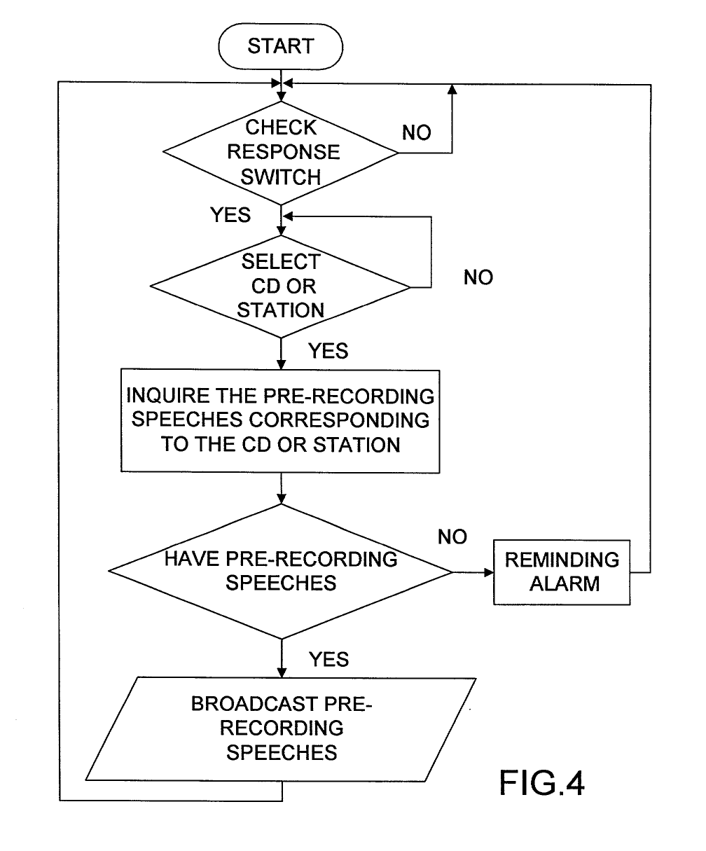

The processing flow set forth above illustrates the steps which users employ the invention to pre-record the reminding speeches. When users operate the car stereo, the invention will respond to users' operations according to the following processes (as shown in FIG. 4):

1. Start.

2. Determine if users utilize the first human interface E1 to activate the invention. If activated, proceed the subsequent processing.

3. Determine if users utilize the first human interface E1 to select CD or radio station.

4. If users do not utilize the first interface E1 to select CD or radio station, repeat the step 3; otherwise, the speech recorder and playback unit B1 inquires the pre-recording speeches corresponding to the CD or radio station.

5. If the speech recorder and playback unit B1 finds no pre-recording speeches, the speech recorder and playback unit B1 outputs guiding speeches (such as BB sound or “you do not have pre-recording reminding speeches”), then repeat the step 2; otherwise, the reminder recorder 3 searches the corresponding pre-recording speeches.

6. The speech recorder and playback unit B1 outputs control signals to mute or tune down the car stereo, and orders the second audio selection unit B4 selecting the audio output source, and output through the reminder recorder B3.

7. The second audio processing unit B8 processes the audio signals and through the audio mixer delivering to the speaker of the car stereo to output.

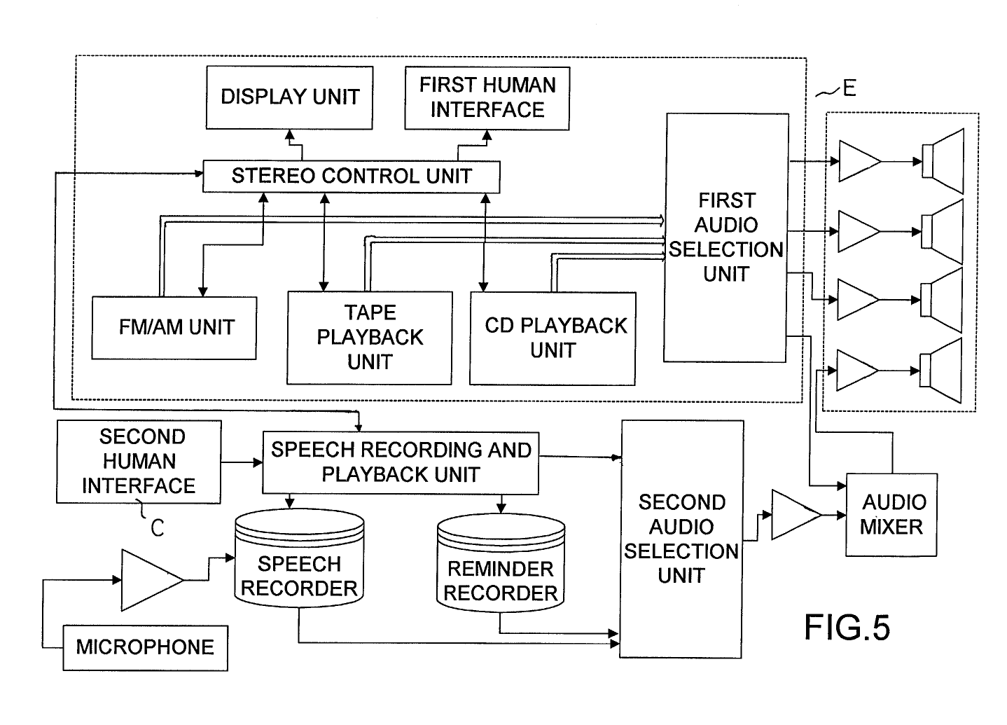

The processing set forth above can effectively resolve the operational problems and shortcomings incurred to the conventional car stereo systems. FIG. 5 shows a second embodiment of the invention. In order to overcome the operational inconveniences that might happen to the first human interface, a second human interface C is provided on the car steering wheel or other desired locations. The second human interface C may be a pushbutton or a turning knob or the like to allow users to enter control commands.

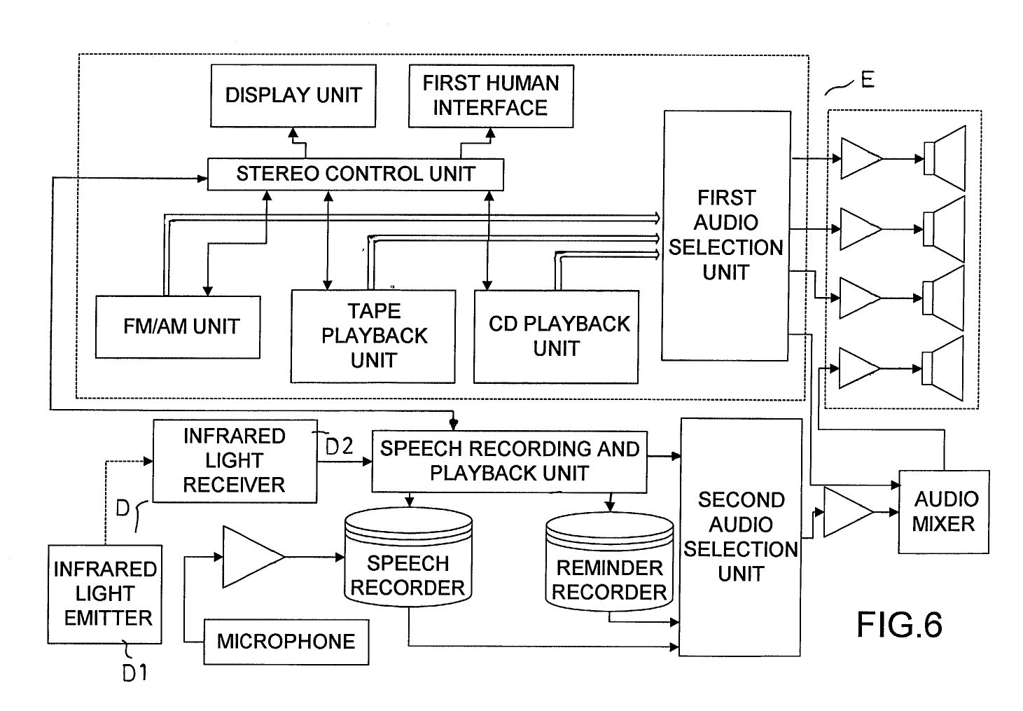

FIG. 6 illustrates a third embodiment of the invention. While the first and second human interface set forth above might be convenient for the people seating on the front seats to control the car stereo, they are not convenient for people seating on the back seats to operate or control. To remedy this problem, an infrared light remote control unit D may be added to the apparatus. The infrared light remote control unit D includes an infrared light receiver Dl and an infrared light emitter D2 which allow users to operate the car stereo or the apparatus of the invention in a remote control fashion.

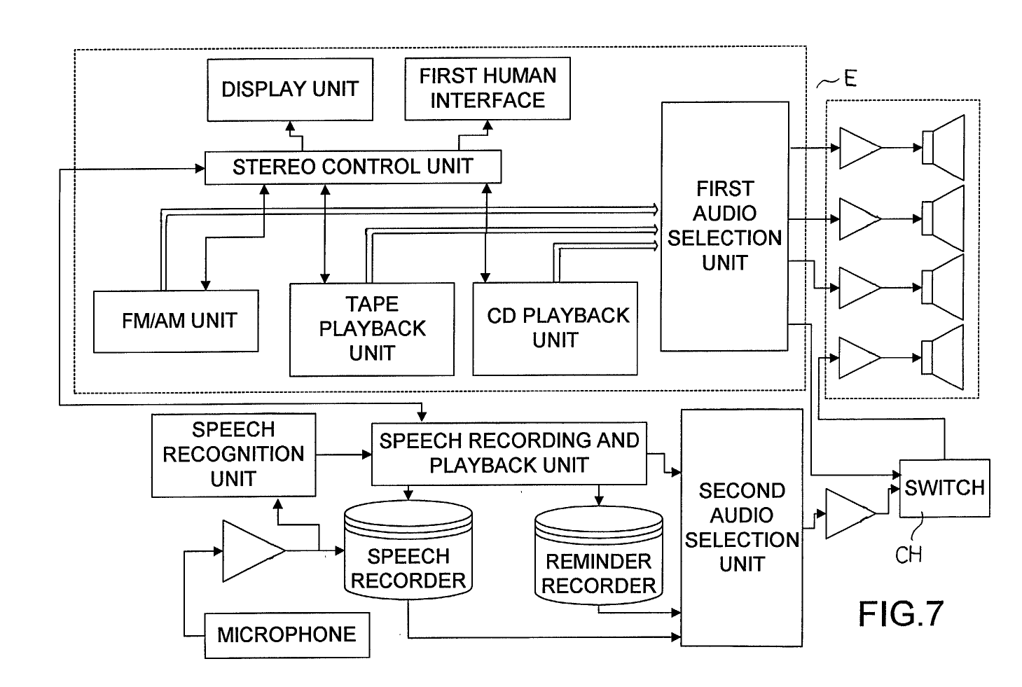

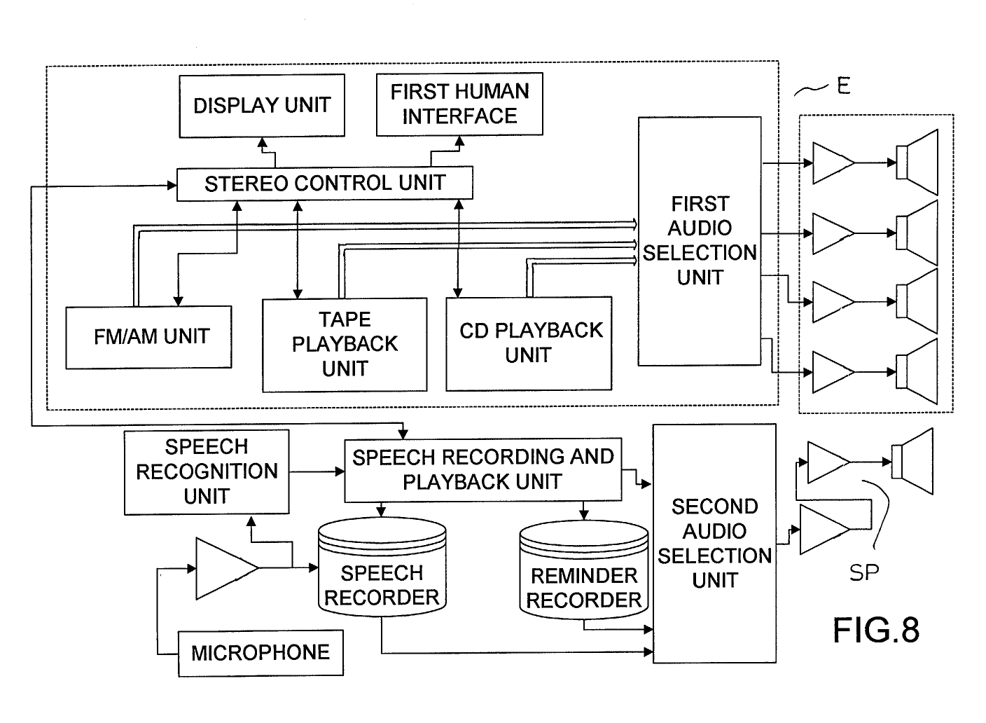

FIGS. 7 and 8 show that the audio mixer of the invention is replaced by a switch CH or an additional external speaker SP to suit different types of cars or users' requirements. Furthermore, a speech recognition unit may be included to allow users to enter input by audio speech, and the speech recognition unit can recognize the input audio speech to control the operations of the apparatus.

The descriptions set forth above indicate that the present invention is simply structured and can effectively overcome the problem of no immediate confirmation that happens to the conventional car stereo systems. By means of the invention, users can greatly shorten the operation time on the car stereo and enhance safety driving.

While the preferred embodiments of the invention have been set forth for the purpose of disclosure, modifications of the disclosed embodiments of the invention as well as other embodiment thereof may occur to those skilled in the art. Accordingly, the appended claims are intended to cover all embodiments which do not depart from the spirit and scope of the invention.

I claim:

1. A speech apparatus responsive to operations of a car stereo, comprising:
a speech recording and playback unit linking to a car stereo control unit of the car stereo to control tuning down or muting of the car stereo, and to control the reminder recorder, the speech recorder, and the second audio selection unit to allow users to record or broadcast instructions or reminding speeches;
a speech recorder for storing operation guiding speeches to lead users;
a reminder recorder for temporarily storing users' recording speech data;
a second audio selection unit for restricting audio signals output from the speech recorder or the reminder recorder;
an audio mixer for blending audio signals output by the second audio selection unit and the car stereo and outputting through a speaker;
a microphone for users to input speech signals;
a first audio processing unit for processing the input speeches; and
a second audio processing unit for processing the audio signals output by the second audio selection unit and outputting through the speaker;
wherein the apparatus responds the operations of selection of car stereo function or CD by audio speeches.

2. The speech apparatus of claim 1 further having a second human interface mounted to the steering wheel of the car or other selected locations.

3. The speech apparatus of claim 1 further having an infrared light remote control unit which includes an infrared light receiver and an infrared light emitter.

4. The speech apparatus of claim 1, wherein the audio mixer is replaced by a switch.

5. The speech apparatus of claim 1, wherein the audio mixer is replaced by an external speaker.
